(19) United States
(12) Patent Application Publication
(10) Pub. No.: US 2001/0015580 A1
(43) Pub. Date: Aug. 23, 2001

(54) Linear Actuator

(76) Inventors: Toshio Sato, Ibaraki-ken (JP); Shogo Miyazaki, Ibaraki-ken (JP); Yoshiteru Ueno, Ibaraki-ken (JP)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 09/784,182

(22) Filed: Feb. 16, 2001

(30) Foreign Application Priority Data
Feb. 18, 2000 (JP) 2000-042054

(51) Int. Cl. H02K 41/00

(52) U.S. Cl. 310/12

(57) ABSTRACT

A linear actuator comprises a driving section composed of a magnet-based rodless cylinder, a slider for making displacement in accordance with a driving action of the driving section, a guide rail for linearly guiding the slider, and a pair of end blocks connected to a first end and a second end of the driving section respectively, wherein the guide rail, which is installed in a recess of the slider, has a size in a widthwise direction substantially perpendicular to a displacement direction of the slider, the size being set to be smaller than a width of the slider.

### BACKGROUND OF THE INVENTION

1. Field of the Invention

The present invention relates to a linear actuator which makes it possible to move a slider linearly and reciprocatively along a guide rail in accordance with the driving action of a driving source.

2. Description of the Related Art

A linear actuator has been hitherto used, for example, as a transport means for a workpiece. As shown in FIG. 14, such a linear actuator has a magnet-based rodless cylinder 5 for displacing a slider 4 along a cylindrical member 3 in accordance with the attracting action of magnets 2 installed to a piston 1, and a guide rail 6 for guiding the slider 4. The magnet-based rodless cylinder 5 and the guide rail 6 are aligned substantially in parallel to one another in the longitudinal direction respectively (see Japanese Laid-Open Patent Publication No. 7-248006).

As shown in FIG. 15, another linear actuator concerning the conventional technique has a lengthy guide rail 8 which is formed with a recess 7 having a substantially angular U-shaped cross section extending in the longitudinal direction, and a slider 9 which is formed to have a width narrower than that of the recess 7 and which is arranged displaceably along the recess 7. Rolling grooves, which are used to cause rolling movement of a plurality of balls 9a arranged between the guide rail 8 and the slider 9, are formed on inner wall surfaces of the guide rail 8 (see Japanese Laid-Open Patent Publication No. 10-318209).

However, in the case of the linear actuator concerning the conventional technique shown in FIG. 14, the magnet-based rodless cylinder 5 and the guide rail 6 are arranged substantially in parallel to one another. Therefore, the following inconvenience arises. That is, the size in the widthwise direction (direction substantially perpendicular to the longitudinal direction) of the entire apparatus is increased, and it is impossible to realize a small size.

The linear actuator shown in FIG. 15 is constructed such that the slider 9 is displaced along the recess 7 formed at the inside of the guide rail 8. Therefore, the following inconvenience arises. That is, the size of the guide rail 8 in the widthwise direction is large as compared with the size of the slider 9 in the widthwise direction. As a result, the weight of the entire apparatus is increased.

Further, in the case of the linear actuator shown in FIG. 15, it is necessary that the diameter A of the circulating track for circulating the balls 9a is generally set to be about 2.5 times the diameter of the ball 9a. Therefore, the size which is twice the diameter A of the circulating track and the outer diameter B of the cylindrical member of the rodless cylinder are indispensable for the size of the guide rail 8 in the widthwise direction, in the case of the linear actuator concerning the conventional technique. Therefore, the following inconvenience arises. That is, it is impossible to reduce the size of the guide rail 8 in the widthwise direction.

### SUMMARY OF THE INVENTION

A general object of the present invention is to provide a linear actuator which makes it possible to reduce the size of a guide rail in the widthwise direction and realize a small size and a light weight.

A principal object of the present invention is to provide a linear actuator which makes it possible to suppress the size in the height direction by arranging a cylindrical member along the inside of a recess which extends in the axial direction of a guide rail and which is formed to have a semicircular cross section.

Another object of the present invention is to provide a linear actuator which makes it possible to absorb fine movement of a slide block in a direction substantially perpendicular to a displacement direction on a substantially horizontal plane, and fine movement of the slide block in substantially vertically upward and downward directions respectively by providing a floating mechanism.

Still another object of the present invention is to provide a linear actuator which makes it possible to reduce the sliding resistance of a slider which is displaceable along a guide rail, by additionally providing a lubricating member for the slider.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a perspective view illustrating a linear actuator according to an embodiment of the present invention;

FIG. 2 shows an exploded perspective view illustrating a state in which a sensor attachment rail is removed from the linear actuator shown in FIG. 1;

FIG. 3 shows an exploded perspective view illustrating a slider for constructing the linear actuator shown in FIG. 1;

FIG. 4 shows, with partial cutout, a plan view illustrating the linear actuator shown in FIG. 1;

FIG. 5 shows a vertical sectional view taken along a line V-V shown in FIG. 4;

FIG. 6 shows a longitudinal sectional view taken along a line VI-VI shown in FIG. 4;

FIG. 7 shows, with partial omission, a longitudinal sectional view illustrating a modified embodiment of a driving section in which only outer magnets are provided at the outside of a cylindrical member;

FIG. 8 shows, with partial omission, a longitudinal sectional view illustrating a modified embodiment of the driving section in which only inner magnets are provided at the inside of a cylindrical member;

FIG. 9 shows, with partial cutout, a side view illustrating the linear actuator shown in FIG. 1;

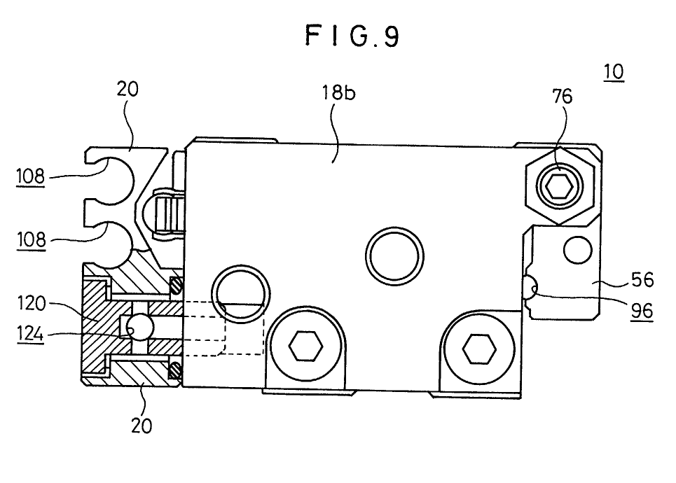

FIG. 10 shows a vertical sectional view illustrating an attachment state of a support member;

FIG. 11 shows a plan view illustrating a linear 10 actuator according to another embodiment of the present invention;

FIG. 12 shows a vertical sectional view taken along a line XII-XII shown in FIG. 11;

FIG. 13 shows, with partial omission, a lateral sectional view illustrating a linear actuator according to still another embodiment of the present invention;

FIG. 14 shows, with partial cutout, a plan view illustrating a linear actuator concerning the conventional technique; and

FIG. 15 shows a vertical sectional view illustrating a linear actuator concerning another conventional technique.

### DESCRIPTION OF THE PREFERRED EMBODIMENTS

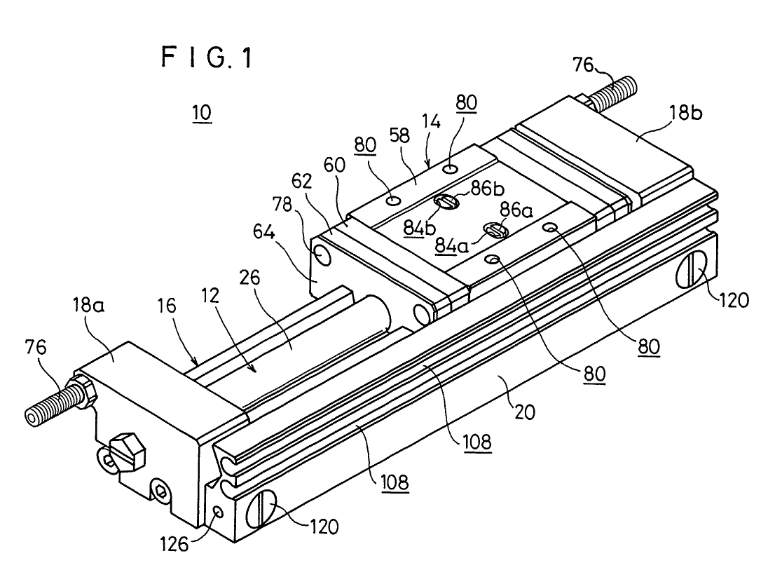

In FIG. 1, reference numeral 10 indicates a linear actuator according to an embodiment of the present invention.

The linear actuator 10 comprises a driving section 12 which is substantially composed of a magnet-based rodless cylinder, a slider 14 which makes reciprocating movement linearly in accordance with the driving action of the driving section 12, a guide rail 16 which linearly guides the slider 14, a pair of end blocks 18a, 18b which are connected to both ends of the guide rail 16 respectively, and a sensor attachment rail 20 which is fixed to the pair of end blocks 18a, 18b respectively and which is arranged substantially in parallel to the guide rail 16.

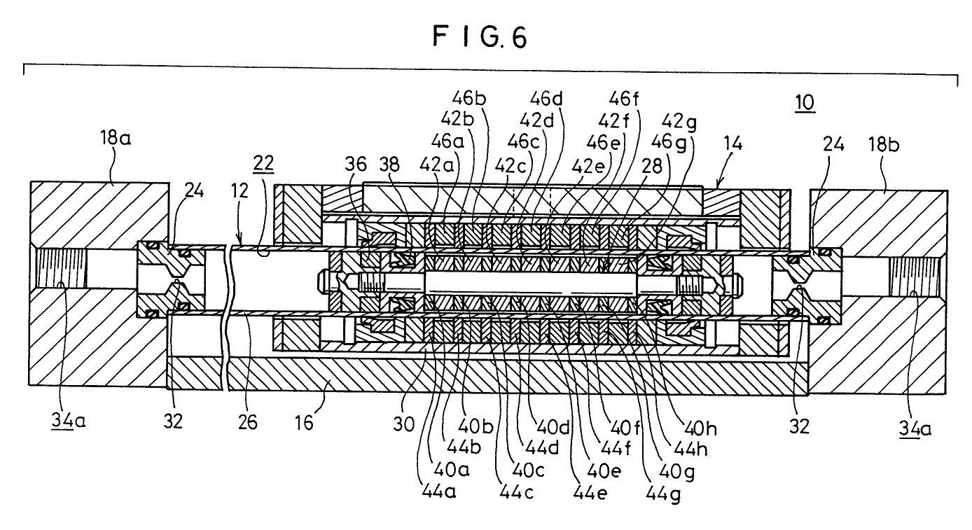

As shown in FIG. 6, the driving section 12 includes a cylindrical member 26 which has a through-hole 22 formed at the inside thereof to function as a cylinder chamber and which is supported by the pair of end blocks 18a, 18b by the aid of end caps 24 installed to its both ends respectively, a piston 28 which is formed of a magnetic material and which is provided slidably along the through-hole 22 of the cylindrical member 26, and a slide block 30 which surrounds the outer circumferential surface of the cylindrical member 26 and which is displaceable in the axial direction of the cylindrical member 26 integrally with the piston 28. The end cap 24 is formed with an orifice 32 for throttling the flow rate of a fluid flowing through the passage.

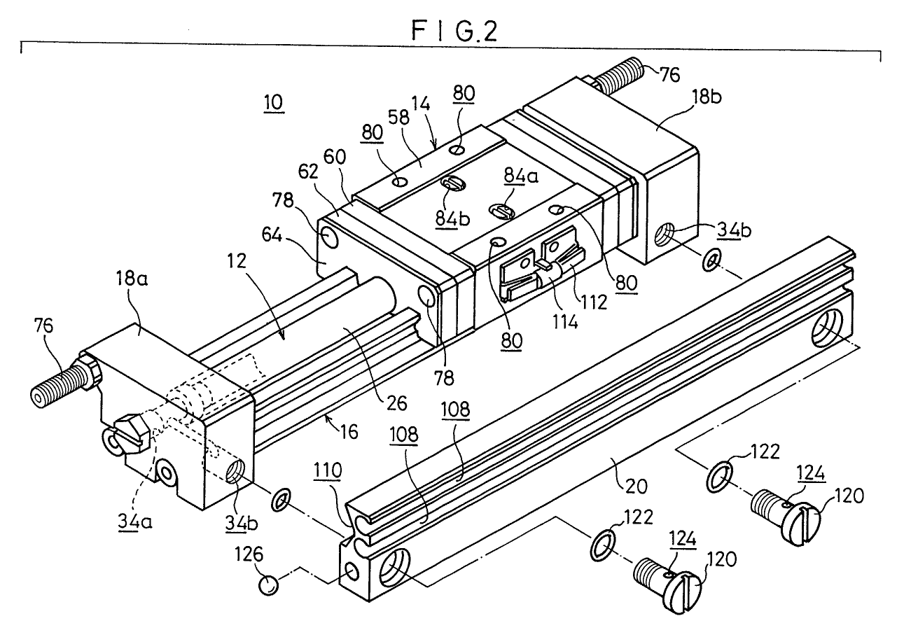

As shown in FIG. 2, each of the end blocks 18a (18b) has a first pressure fluid inlet/outlet port 34a which is formed substantially in parallel to the axis of the cylindrical member 26, and a second pressure fluid inlet/outlet port 34b which is formed in a direction substantially perpendicular to the axis of the cylindrical member 26.

As shown in FIG. 6, wear rings 36 and scrapers 38 are installed on the sides of the both ends of the piston 28 in the axial direction respectively. A first yoke, which comprises eight annular plates 40a to 40h formed of a magnetic member such as iron, is externally fitted to the outer circumferential surface of the piston 28. Ring-shaped inner magnets 42a to 42g are interposed between the adjacent annular plates 40a to 40h respectively.

A second yoke, which is composed of a magnetic member such as iron and which comprises annular plates 44a to 44h divided into a plurality of individuals, is internally fitted to the inner circumferential surface of the slide block 30. Ring-shaped outer magnets 46a to 46g are interposed between the adjacent annular plates 44a to 44h respectively. In this arrangement, the inner magnets 42a to 42g installed to the piston 28 and the outer magnets 46a to 46g installed to the slide block 30 are arranged to be confronted with each other with the cylindrical member 26 intervening therebetween respectively. Further, the inner magnets 42a to 42g and the outer magnets 46a to 46g have their polarities which are set to make attraction to one another.

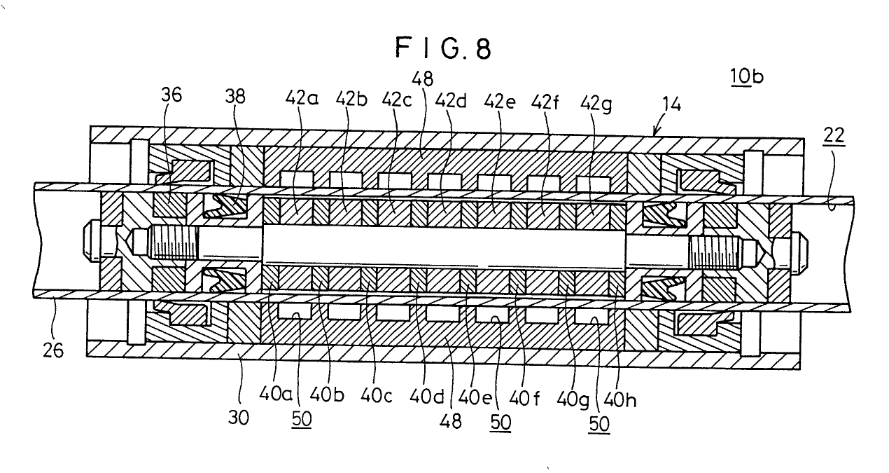

The embodiment of the present invention is constructed by using the inner magnets 42a to 42g which are installed to the piston 28 by the aid of the first yoke, and the outer magnets 46a to 46g which are installed to the slide block 30 by the aid of the second yoke. However, there is no limitation thereto. As shown in FIG. 8, it is also preferable that only a second 48, which is formed of a magnetic member in an integrated manner, is connected to the slide block 30, without providing the outer magnets 46a to 46g.

This arrangement has the following advantage. That is, it is possible to contemplate the reduction of cost by decreasing the number of parts. Further, it is possible to suppress the contour size of the slide block 30 owing to the second yoke 48 and the slide block 30 which are formed in the integrated manner. In FIG. 8, reference numeral 50 indicates a plurality of annular recesses which are formed and separated from each other by predetermined spacing distances in the axial direction of the second yoke 48.

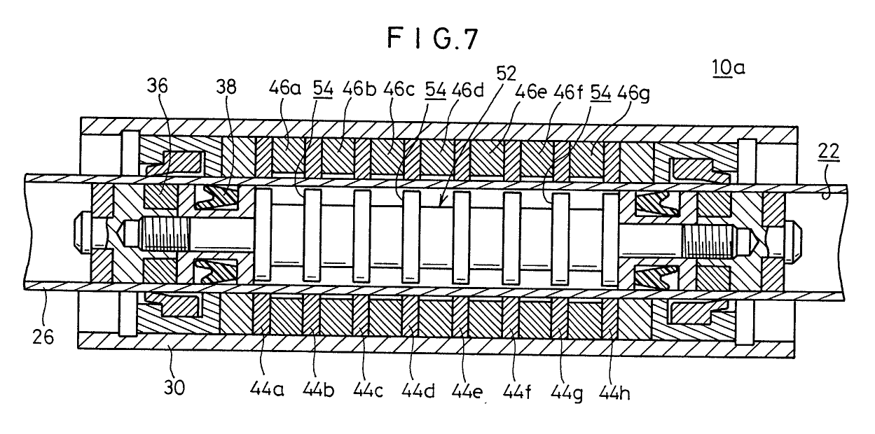

Alternatively, as shown in FIG. 7, it is also preferable that a piston 52 is formed integrally with the first yoke with a magnetic material, without providing the inner magnets 42a to 42g. In this arrangement, it is possible to reduce the cost by decreasing the number of parts. It is preferable for the piston 52 to form a plurality of annular recesses 54 which are separated from each other by predetermined spacing distances in the axial direction.

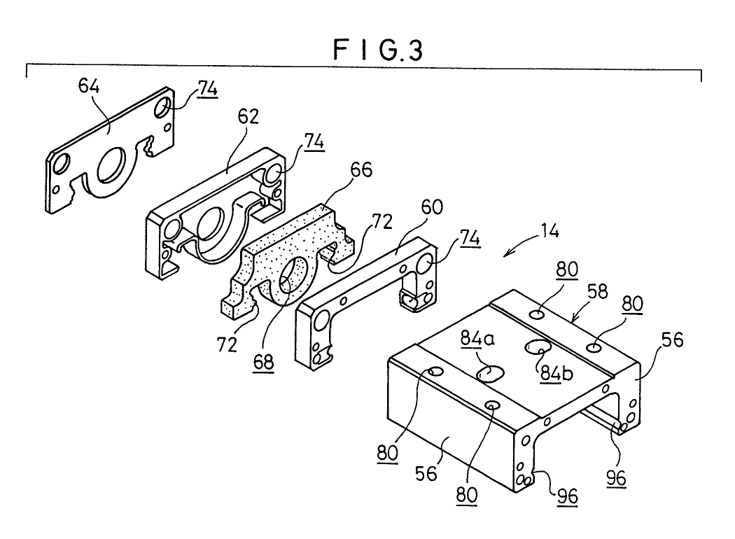

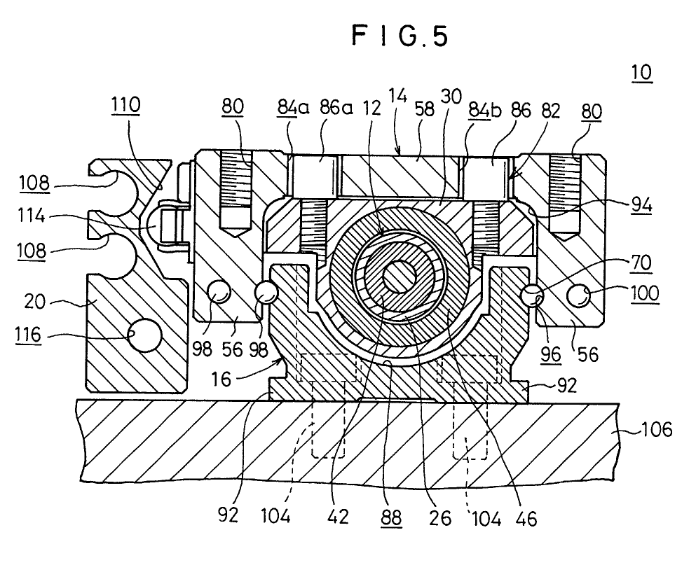

As shown in FIGS. 3 and 5, the slider 14 includes a guide block 58 which has a substantially U-shaped cross section and which is integrally formed with a pair of side sections 56 separated from each other by a predetermined spacing distance and mutually opposed to one another, return passage-forming members 60 which are connected to both ends of the guide block 58 in the stroke direction, cover members 62 which are connected to the return passage-forming members 60, and plate-shaped scrapers 64 which are connected to the cover members 62.

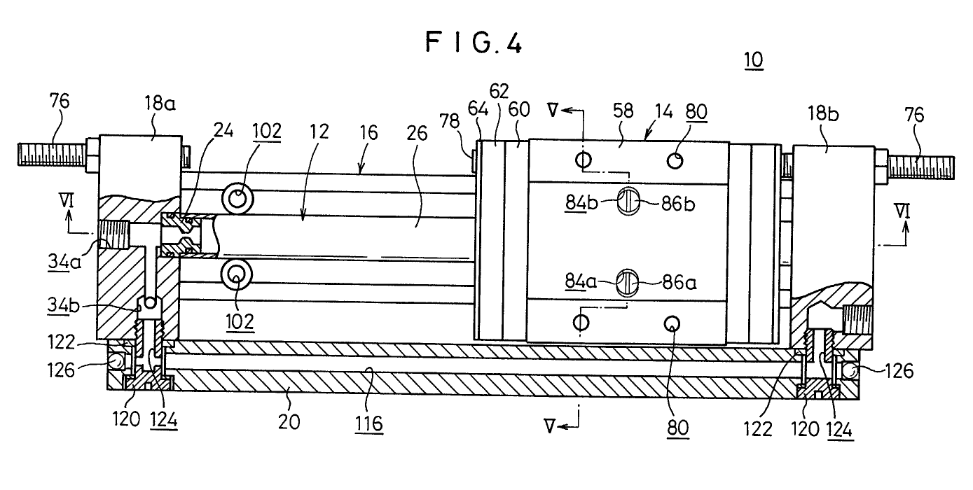

A lubricating member 66, which is composed of a porous material and which is impregnated with lubricating oil, is installed to a recess of the cover member 62. The lubricating member 66 is formed with a hole 68 having a substantially circular configuration to make sliding contact with the outer circumferential surface of the cylindrical member 26, and projections 72 to make sliding contact with rolling grooves 70 of the guide rail 16 (as described later on). Holes 74 are penetratingly formed through the scraper 64, the cover member 62, and the return passage-forming member 60 respectively. Elastic members 78, against which screw members 76 abut as described later on, are installed to the holes 74 (see FIG. 4).

Owing to the provision of the lubricating member 66, the lubricating oil is applied to the outer circumferential surface of the cylindrical member 26 and the rolling grooves 70 of the guide rail 16. Thus, it is possible to reduce the sliding resistance when the slider 14 is displaced, and it is possible to ensure the smooth displacement action.

Four workpiece attachment holes 80 are formed at flat surface portions of the guide block 58. A floating mechanism 82, which absorbs any deviation of the slide block 30 upon the displacement along the cylindrical member 26, is provided between the workpiece attachment holes 80.

As shown in FIG. 4, the floating mechanism 82 includes a pair of long holes 84a, 84b which are formed at flat surface portions of the guide block 58 and each of which is formed to have a large diameter in a direction substantially perpendicular to the stroke direction of the guide block 58, and a pair of studs 86a, 86b which have their first ends screw-fastened to the slide block 30 and which have their second ends loosely fitted to the long holes 84a, 84b respectively.

The rectilinear motion of the slide block 30 displaced along the cylindrical member 26 is transmitted to the guide block 58 by the aid of the studs 86a, 86b which are screw-fastened to the slide block 30, and thus the piston 28, the slide block 30, and the guide block 58 are displaced in an integrated manner. In other words, the rectilinear motion of the slide block 30 is transmitted to the guide block 58 in accordance with the engaging action of the studs 86a, 86b with respect to the long holes 84a, 84b, wherein the slide block 30 and the guide block 58 are not connected to one another.

Therefore, any deviation, which is generated when the slide block 30 is displaced along the cylindrical member 26 if the parallel accuracy is not maintained completely with respect to the rolling grooves 70, 96 (as described later on) to function as the endless circulating tracks, is absorbed in accordance with the engaging action between the long holes 84a, 84b and the studs 86a, 86b which are connected to the slide block 30. Therefore, it is possible to smoothly transport an unillustrated workpiece.

The screw members 76, which adjust the stroke amount of the slider 14, are screwed into corner portions of the 10 respective end blocks 18a, 18b. The stroke amount of the slider 14 is adjusted by increasing or decreasing the screwing amount of the screw members 76.

The guide rail 16 is composed of a lengthy pillar-shaped member. As shown in FIG. 5, the guide rail 16 includes a recess 88 which has a semicircular cross section and which is formed to extend in the longitudinal direction at its upper surface portion, a pair of rolling grooves 70 each of which has a circular arc-shaped cross section and which are formed to extend in the longitudinal direction with respect to the side sections 56 opposed to one another, and flanges 92 which extend in the longitudinal direction and with which support members 90 are engaged as described later on. An approximately half portion of the cylindrical member 26 disposed on the lower side is installed to face the inside of the recess 88 having the semicircular cross section. A predetermined clearance is formed between the recess 88 and the cylindrical member 26.

When the recess 88 is provided for the guide rail 16, and the cylindrical member 26 is installed to face the recess 88 as described above, then an advantage is obtained such that it is possible to suppress the size of the entire apparatus in the height direction.

The guide rail 16 is provided to face the inside of a recess 94 which is formed by the pair of mutually opposing side sections 56 of the guide block 58. Therefore, it is possible to set a small size of the guide rail 16 in the widthwise direction (size in the direction substantially perpendicular to the axis) with respect to the size between the pair of side sections 56 of the guide block 58.

In this arrangement, a plurality of balls 98 are rollably installed between the rolling grooves 96 which are formed on the side sections 56 of the guide block 58 and the rolling grooves 70 which are formed on the guide rail 16. The endless circulating tracks are formed by the rolling grooves 70, 96 and through-holes 100 which are formed through the side sections 56 of the guide block 58.

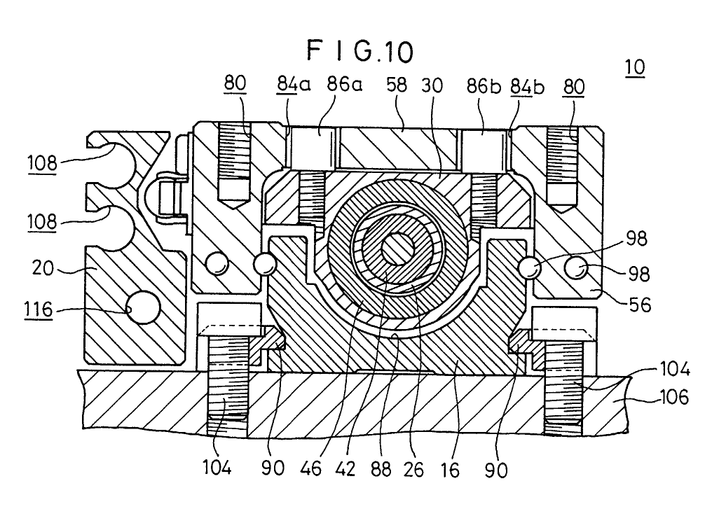

The guide rail 16 may be fixed to another member 106 by the aid of bolts 104 which are inserted into a pair of penetrating attachment holes 102 (see FIG. 4). Alternatively, as shown in FIG. 10, the guide rail 16 may be fixed to another member 106 by the aid of a pair of support members 90 which are engaged with the flanges 92.

Two stripes of sensor attachment long holes 108, which are substantially parallel to one another in the axial direction and each of which has a circular arc-shaped cross section, are formed on one side surface of the sensor attachment rail 20. A recess 110, which has a triangular cross section, is formed in the axial direction on another side surface which is disposed on the opposite side. A magnet 114, which is held by the guide block 58 by the aid of an attachment fixture 112, faces the recess 110. The position of the slider 14 can be detected by sensing the magnetic field of the magnet 114 which is displaced integrally with the guide block 58, by means of an unillustrated sensor which is installed to the sensor attachment long hole 108.

As shown in FIG. 4, a passage 116, which extends in the axial direction, is formed at the inside of the sensor attachment rail 20. The passage 116 is provided to make communication with the pressure fluid inlet/outlet ports 34b formed for the end blocks 18a, 18b respectively, by the aid of piping studs 120 which are fitted to a pair of holes formed on the lower side of the sensor attachment long hole 108 respectively. In FIGS. 2 and 4, reference numeral 122 indicates seal rings.

In this arrangement, the piping stud 120 has both of a function to attach the sensor attachment rail 20 to the end block 18a, 18b, and a function to make communication between the second pressure fluid inlet/outlet port 34b of the end block 18a, 18b and the passage 116 of the sensor attachment rail 20 through a communication passage 124 which is formed in the piping stud 120. Therefore, the degree of freedom concerning the direction to lead the piping is improved by forming the passage 116 for allowing the pressure fluid to flow therethrough in the sensor attachment rail 20. Further, it is unnecessary to connect tubes to the pair of end blocks 18a, 18b respectively, and it is enough to connect a tube to any one of the end blocks 18a (18b). Therefore, it is possible to simplify the piping arrangement.

Both ends of the passage 116 formed in the sensor attachment rail 20 are closed in an air-tight manner by steel balls 126 respectively.

The linear actuator 10 according to the embodiment of the present invention is basically constructed as described above. Next, its operation, function, and effect will be explained.

The pressure fluid (for example, compressed air), which is supplied from an unillustrated pressure fluid supply source, passes through the first pressure fluid inlet/outlet port 34a, and it is introduced into the through-hole 22 of the cylindrical member 26 which functions as the cylinder chamber. The piston 28 is pressed in accordance with the action of the pressure fluid introduced into the through-hole 22 of the cylindrical member 26. The plurality of inner magnets 42a to 42g and the piston 28 are displaced integrally along the through-hole 22 of the cylindrical member 26 by the aid of the first yoke composed of the annular plates 40a to 40h. During this process, the outer magnets 46a to 46g are attracted in accordance with the action of the magnetic fields of the inner magnets 42a to 42g installed to the piston 28 by the aid of the first yoke. The slide block 30, which holds the outer magnets 46a to 46g, is displaced integrally with the piston 28.

When the slide block 30 is displaced along the cylindrical member 26, the plurality of balls 98, which are installed between the guide rail 16 and the side sections 56 of the guide block 58, roll along the rolling grooves 70, 96 which function as the endless circulating tracks. Accordingly, the guiding action is effected for the guide block 58. The rectilinear motion of the slide block 30 is transmitted to the guide block 58 by the aid of the studs 86a, 86b. As a result, the piston 28, the slide block 30, and the guide block 58 are displaced linearly in an integrated manner. Accordingly, the reciprocating rectilinear motion of the slider 14 is maintained.

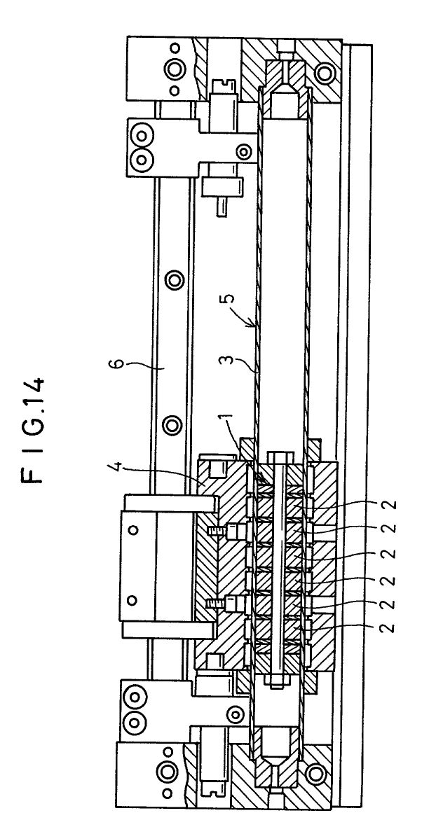

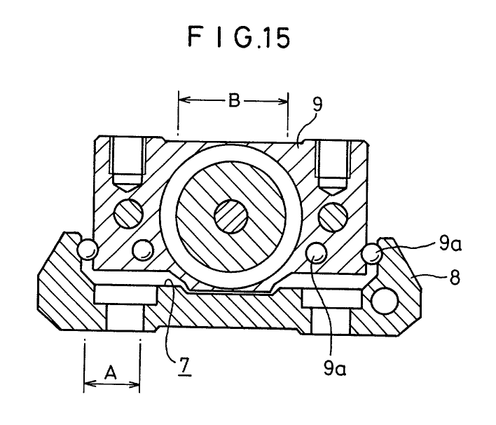

In the embodiment of the present invention, the guide rail 16 is provided to face the inside of the recess 94 which is formed by the pair of mutually opposing side sections 56 of the guide block 58. Accordingly, the size of the guide rail 16 in the widthwise direction (size in the direction substantially perpendicular to the axis) can be set to be small as compared with the conventional techniques shown in FIGS. 14 and 15. Therefore, in the embodiment of the present invention, it is possible to reduce the weight of the entire apparatus, and it is possible to realize the light weight.

In the embodiment of the present invention, the size of the guide rail 16 in the widthwise direction can be set without being affected by the size of the diameter A of the circulating track in which the balls 98 roll. Therefore, the size of the guide rail 16 in the widthwise direction can be further reduced. In the embodiment of the present invention, the size of the guide rail 16 in the widthwise direction is set in conformity with the outer diameter of the cylindrical member 26 and the size which is twice the diameter of the attachment hole 102 formed for the guide rail 16.

In the embodiment of the present invention, when the slider 14 is displaced along the cylindrical member 26, any deviation of the parallel accuracy between the cylindrical member 26 and the rolling grooves 70, 96 is absorbed in accordance with the engaging action between the studs 86a, 86b which are connected to the slide block 30 and the long holes 84a, 84b which are formed for the guide block 58. Therefore, it is possible to smoothly displace the workpiece.

That is, when the parallel accuracy between the axis of the cylindrical member 26 and the axes of the rolling grooves 70, 96 is not complete, any deviation occurs in the slide block 30 which is displaced along the cylindrical member 26 in accordance with the guiding action of the rolling grooves 70, 96. In this situation, the deviation, which is generated in the widthwise direction substantially perpendicular to the displacement direction of the slider 14 on the substantially horizontal plane, is absorbed by the displacement by minute distances of the slide block 30 and the studs 86a, 86b in the integrated manner in the widthwise direction in accordance with the engaging action of the studs 86a, 86b with respect to the long holes 84a, 84b.

The deviation, which is generated in the substantially vertical direction (vertically upward and downward directions) of the slide block 30, is preferably absorbed by the vertical movement by minute distances of the slide block 30 and the studs 86a, 86b in the integrated manner in accordance with the engaging action of the studs 86a, 86b with respect to the long holes 84a, 84b.

Therefore, even when any deviation is generated when the slide block 30 makes the reciprocating rectilinear motion along the cylindrical member 26, it is possible to smoothly transport the workpiece. As a result, when the linear actuator 10 is assembled, it is unnecessary to accomplish the complete parallel accuracy for the axis of the cylindrical member 26 and the axes of the rolling grooves 70, 96. Accordingly, it is possible to simplify the assembling steps, and it is possible to reduce the production cost.

Further, in the embodiment of the present invention, the passage 116 for piping is formed in the sensor attachment rail 20. Accordingly, it is possible to realize the convenient piping operation, and it is possible to effectively utilize the piping space.

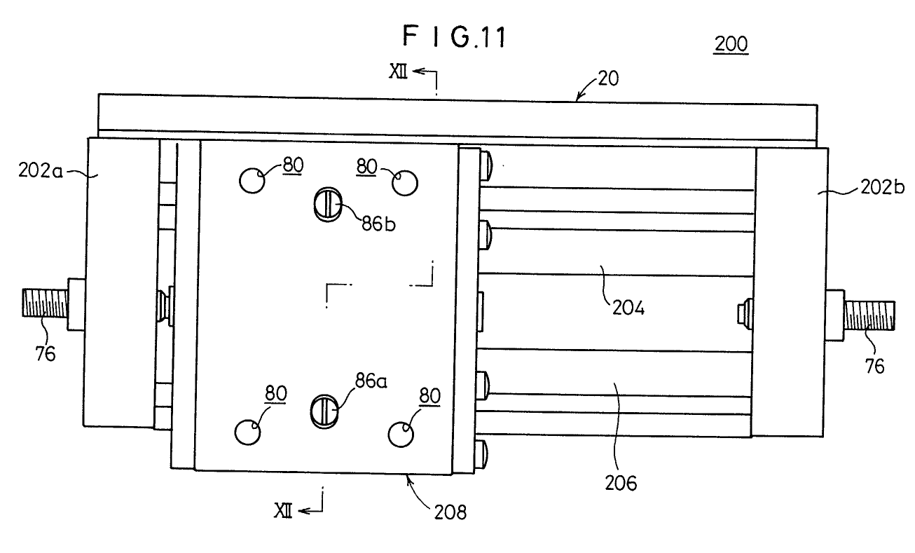

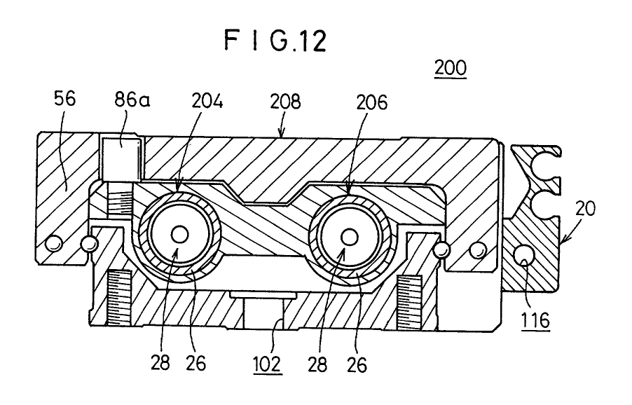

Next, a linear actuator according to another embodiment of the present invention is shown in FIGS. 11 and 12. In the embodiment described below, the same constitutive components as those referred to in the embodiment according to the present invention described above are designated by the same reference numerals, detailed explanation of which will be omitted.

The linear actuator 200 according to the another embodiment is characterized in that a first driving section 204 and a second driving section 206, which are substantially composed of magnet-based rodless cylinders, are aligned substantially in parallel to one another while being separated from each other by a predetermined spacing distance between a pair of end blocks 202a, 202b. Each of the first driving section 204 and the second driving section 206 is constructed in the same manner as the driving section 12 according to the embodiment described above, detailed explanation of which will be omitted.

In the linear actuator 200 according to the another embodiment, the first driving section 204 and the second driving section 206 are aligned substantially in parallel to one another respectively. Accordingly, the following advantage is obtained. That is, the driving force for displacing the slider 208 can be strengthened about twice. Further, it is possible to enhance the moment in the rolling direction.

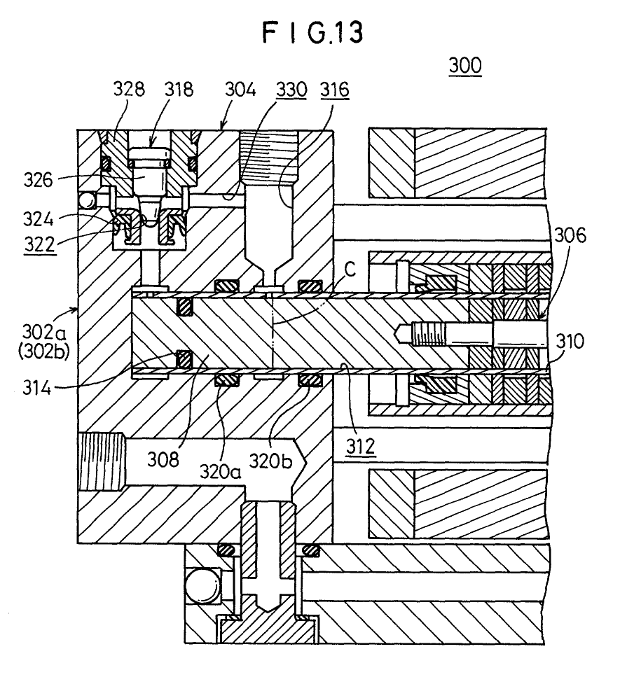

Next, a linear actuator 300 according to still another embodiment of the present invention is shown in FIG. 13.

The linear actuator 300 according to the still another embodiment is characterized in that air cushion mechanisms 304 are provided for a pair of end blocks 302a, 302b respectively. The air cushion mechanisms 304, which are provided for the pair of end blocks 302a, 302b respectively, are constructed in an identical manner. Therefore, only one of them will be explained in detail, and the other will be omitted from explanation.

Each of the air cushion mechanisms 304 includes one of a pair of rod members 308 which are substantially coaxially connected to both ends of a piston 306 and which are displaceable integrally with the piston 306, a seal member 314 which is installed to an annular groove formed on the outer circumferential surface of the rod member 308 and which effects the sealing function by making sliding contact with the inner circumferential surface of a through-hole 312 of a cylindrical member 310, a discharge port 316 which is formed in the end block 302a and which discharges the air in the through-hole 312 to the outside, and a throttle means 318 which is provided at a portion disposed closely to the discharge port 316 and which suppresses the displacement amount when the air in the cylindrical member 310 is discharged to the outside.

The throttle means 318 has a throttle hole 322 for regulating the discharge amount, a check valve 324 for obstructing the flow of air which does not pass through the throttle hole 322, an adjusting member 326 for adjusting the opening area of the throttle hole 322, and a valve member 328 to which the adjusting member 326 is internally fitted. The throttle hole 322 is provided to make communication with the discharge port 316 via a communication passage 330. In this arrangement, it is also preferable to use an unillustrated mechanism of the fixed throttle type, in place of the mechanism of the variable throttle type in which the opening area of the throttle hole 322 is adjusted by using the first end of the adjusting member 326.

A pair of seal rings 320a, 320b are installed in the hole of the end block 302a with the discharge port 316 intervening therebetween.

The operation of the air cushion mechanism 304 will be explained. When the rod member 308 is moved toward the first displacement terminal position along the through-hole 312 of the cylindrical member 310 integrally with the piston 306, the air, which remains in the through-hole 312 of the cylindrical member 310, is principally discharged from the discharge port 316 to the outside, before the seal member 314, which is installed to the outer circumferential surface of the rod member 308, passes over the position of the discharge port 316, i.e., over the position indicated by a two-dot chain line C shown in FIG. 13.

After the piston 306 is further displaced to allow the seal member 314 of the rod member 308 to pass over the discharge port 316, the sealing is effected by the seal member 314 which makes the sliding contact with the inner circumferential surface of the through-hole 312 of the cylindrical member 310. Therefore, the air remaining in the through-hole 312 is prevented from being directly discharged from the discharge port 316.

That is, after the seal member 314 of the rod member 308 passes over the discharge port 316, the air, which remains in the through-hole 312, is throttled by the throttle hole 322 which is adjusted for the pressure in accordance with the spacing distance with respect to the first end of the adjusting member 326. The air is discharged from the discharge port 316 to the outside via the communication passage 330.

Therefore, after the seal member 314 passes over the discharge port 316, i.e., until the seal member 314 passes over the position of the two-dot chain line C to arrive at the displacement terminal position, the air is discharged to the outside via the throttle means 318, and the flow rate of the air flowing through the throttle means 318 is throttled. Accordingly, the buffering action is effected.

When the air cushion mechanism 304 is provided as described above, then it is possible to mitigate the shock which would be otherwise caused at the displacement terminal position of the slider 14, it is possible to suppress the sound of the shock, and it is possible to smoothly perform the reciprocating rectilinear motion of the slider 14. The power for absorbing the kinetic energy of the slider 14 at the displacement terminal position is increased in the air cushion mechanism 304. Accordingly, it is possible to move a workpiece including a heavy matter at a high speed. Further, the generation of dust, which would be otherwise caused when the buffering action is effected, is suppressed. Accordingly, an advantage is obtained such that the linear actuator can be preferably used in an environment of use in which the cleanness is required.

What is claimed is:

1. A linear actuator comprising:
a driving section;
a slider for making displacement in accordance with a driving action of said driving section;
a guide mechanism for linearly guiding said slider; and
a pair of end blocks connected to a first end and a second end of said driving section respectively, wherein:
said guide mechanism includes a guide rail which is installed in a recess of said slider and which has its both ends connected to said pair of end blocks respectively, and a size of said guide rail in a widthwise direction substantially perpendicular to a displacement direction of said slider is set to be smaller than a width of said slider.

2. The linear actuator according to claim 1, wherein said driving section is composed of a magnet-based rodless cylinder including a cylindrical member connected between said pair of end blocks, a piston for making sliding displacement along a through-hole of said cylindrical member in accordance with an action of supplied pressure fluid, inner magnets installed to said piston, a slide block externally fitted to said cylindrical member, and outer magnets installed to said slide block.

3. The linear actuator according to claim 2, wherein said cylindrical member is arranged in a recess and disposed along said recess which extends in an axial direction of said guide rail and which is formed to have a semicircular cross section.

4. The linear actuator according to claim 2, wherein said slider is provided with a floating mechanism for absorbing fine movement of said slide block in a direction substantially perpendicular to said displacement direction on a substantially horizontal plane, and fine movement of said slide block in substantially vertically upward and downward directions respectively.

5. The linear actuator according to claim 4, wherein said slider includes a guide block formed with a pair of mutually opposing side sections, and said floating mechanism has a long hole formed through said guide block, and a stud connected to said slide block for making engagement with said long hole.

6. The linear actuator according to claim 1, wherein said driving section includes a first driving section and a second driving section which are separated from each other by a predetermined spacing distance and which are arranged substantially in parallel to one another, and each of said first driving section and said second driving section is composed of a magnet-based rodless cylinder.

7. The linear actuator according to claim 1, wherein a sensor attachment rail, which is formed with a long hole for installing a sensor, is connected to said pair of end blocks.

8. The linear actuator according to claim 7, wherein said sensor attachment rail is formed with a fluid passage which communicates with pressure fluid inlet/outlet ports formed for said pair of end blocks and which extends in an axial direction.

9. The linear actuator according to claim 1, wherein a buffering mechanism for absorbing any shock at a displacement terminal position of said slider is provided for each of said pair of end blocks.

10. The linear actuator according to claim 9, wherein said buffering mechanism is composed of an air cushion mechanism for effecting buffering function by regulating a flow rate of air to be discharged to the outside of a cylindrical member when a piston is displaced.

11. The linear actuator according to claim 2, wherein said slider is provided with a lubricating member which is formed with a hole for making sliding contact with an outer circumferential surface of said cylindrical member, and projections for making sliding contact with rolling grooves formed for said guide rail, and said lubricating member is composed of a porous material impregnated with lubricating oil.
